(19) United States
(12) Patent Application Publication
(10) Pub. No.: US 2015/0194067 A1
(43) Pub. Date: Jul. 9, 2015

(54) EYEWEAR THAT SIMULATES IMPAIRMENT AND METHOD

(71) Applicant: DRUNK BUSTERS OF AMERICA, L.L.C, BROWNSVILLE, WI (US)

(72) Inventor: CURTIS S. KINDSCHUH, Brownsville, WI (US)

(21) Appl. No.: 14/591,682

(22) Filed: Jan. 7, 2015

Related U.S. Application Data
(60) Provisional application No. 61/924,551, filed on Jan. 7, 2014.
(60) Provisional application No. 61/926,688, filed on Jan. 13, 2014.

(51) Int. Cl. G09B 9/00

(52) U.S. Cl. CPC G09B 9/00

(57) ABSTRACT

Impairment simulating eyewear is disclosed. The eyewear simulates impairment, such as sleep deprivation, or the effects of drug use, through the use of specialized distorting lenses, such as lenticular prism lenses and Fresnel lenses. The lens may be provided with an array of light restricting patterns. The eyewear may include a colored transparent cover.

### RELATED APPLICATIONS

This application claims the benefit of co-pending U.S. Provisional Patent Application Ser. No. 61/924,551, filed on 7 Jan. 2014, and titled “Eyewear that Simulates Sleep Deprivation” and co-pending U.S. Provisional Patent Application Ser. No. 61/926,688, filed on 13 Jan. 2014, and titled “Eyewear that Simulates Impairment”

### BACKGROUND OF THE INVENTION

The detrimental effect of various impairments on the ability of persons to perform common activities is well known. For example, major efforts have been made to rid the highways of intoxicated drivers. Other impairments include sleep deprivation and drug impairment.

A vital part of law enforcement involves educating drivers about the dangers of driving while impaired. As a part of such educational programs, educational equipment has been developed that simulate the effect of impairments. An example of a prior educational aid is a pair of goggles having eyepieces that deceive the wearer as to the actual locations of viewed objects. A person wearing the prior goggles perceives his surroundings as being displaced from their actual locations. Consequently, the wearer becomes disoriented and is unable to perform such simple activities as walking in a straight line. Examples of prior eyewear that induces disorientation may be seen in U.S. Pat. Nos. 4,522,474; 4,698,564; 5,362,238, and 6,206,521, for example.

Despite the availability of existing equipment that simulates intoxication and other incapacity, further development is desirable to mimic specific types of impairment in addition to intoxication. The present invention provides eyewear that simulates the effect of sleep deprivation. Another embodiment simulates the effect of illegal drug use.

### SUMMARY OF THE INVENTION

The present invention is directed to eyewear, particularly eyewear that simulates impairment, such as sleep deprivation, or the effects of drug use, by causing a wearer to perceive objects as being distorted. The eyewear includes an eyepiece made from a specialized lens, for example, a lenticular prism lens having properties that span both eyes of the person. Another embodiment according to the present invention may include an apparatus having an eyepiece made from a Fresnel lens including curved refracting prisms that span both eyes of the person, with the lens being further provided with an array of light restricting patterns.

Eyewear according to the present invention is comprised of a goggle having a frame that is worn on a wearer's face. A goggle eyepiece spans both eyes and is symmetrical about a transverse centerline. The eyepiece is retained around its periphery in the goggle frame.

An embodiment of the present invention simulates the effects of sleep deprivation. The lenticular prism lens from which the goggle eyepiece of this embodiment is made is in the shape of a flat transparent sheet having multiple, closely spaced linear light refracting prisms on one side of the sheet. To protect the eyepiece, and to further simulate a particular time of day, a cover of a colored material may be inserted in the goggle frame over the eyepiece. The colored cover is retained around its periphery in the goggle frame in the same manner as the eyepiece.

A wearer of the eyewear simulating the effects of sleep deprivation views surrounding objects as distorted in a manner that simulates sleep deprivation. The wearer's eyes perceive surrounding objects as being misshapen and blurred. The addition of color to the cover further simulates time of day distortion, with colors in the blue family simulating sleep deprivation in the early morning hours and colors in the red family simulating dusk and early evening times. While colors in the red and blue family are herein disclosed, it is to be understood that other colors may be used without departing from the invention.

A person wearing the sleep deprivation eyewear according to the present invention is unable to satisfactorily perform even very simple tasks, such as walking a straight line. Thus the eyewear simulates bodily impairment similar to that produced by sleep deprivation. The eyewear is an excellent aid for teaching persons of the dangers of driving automobiles and operating other machines while sleep deprived.

According to one aspect of the invention, an eyepiece may be produced from a lenticular prism lens such that the eyepiece transverse centerline coincides with a straight line through the center of the lens. Accordingly, the refracting prisms of the eyepiece are symmetrical about the eyepiece transverse centerline. As a result, the refracting prisms span the entire length of the eyepiece.

In a modified embodiment, the eyepiece is produced such that the eyepiece transverse centerline is perpendicular to lenticular prism lens refracting prisms. For all eyepiece constructions, however, bodily activities are severely impaired.

A method and apparatus of the invention, using a single eyepiece made from a lenticular prism lens and colored cover, thus enables users to safely experience the effects of sleep deprivation. The visual distortions produced by the eyewear of the present invention are temporary and can be terminated at will, even though the distortions are both realistic and economical to produce.

Another embodiment of the present invention may simulate the effects of drug use. In this embodiment, a Fresnel lens is used in the goggle eyepiece. The Fresnel lens used in this embodiment is preferably made in the shape of a flat transparent sheet having multiple closely spaced circular light refracting prisms on one side of the sheet. The refracting prisms are preferably concentric about a center. A side of the sheet preferably includes an array of light restricting patterns. The array may be linear or may be concentric about a center as the refracting prisms. The light restricting patterns may vary in opacity and color according to the desired result.

An eyepiece having a Fresnel lens is preferably produced such that the eyepiece transverse centerline coincides with a straight line through the center of the Fresnel lens. Accordingly, the refracting prisms of the eyepiece are symmetrical about the eyepiece transverse centerline. Preferably, the eyepiece is produced from an area of the Fresnel lens at which the refracting prisms have the largest diameter, i.e., close to the edge of the Fresnel lens sheet. As a result, many of the refracting prisms span the entire length of the eyepiece. To protect the eyepiece, a transparent cover may be inserted in the goggle frame over the eyepiece. The cover is retained around its periphery in the goggle frame in the same manner as the eyepiece. The cover may have a color or may be clear, depending on the degree and type of impairment to be simulated.

When the eyewear having a Fresnel lens eyepiece is worn, the wearer sees surrounding objects in a distorted fashion. One eye perceives objects as being shifted both vertically and horizontally relative to their true positions relative to the wearer. In addition, the curvature of the long refractive prisms causes objects to be perceived as misshapen. The wearer's second eye perceives objects as being shifted in the same vertical direction, but in an opposite horizontal direction, as compared to that of the first eye. The second eye also perceives objects to be misshapen. When the wearer views objects with both eyes, his brain perceives double images that are displaced in opposite directions and are misshapen. A person wearing the eyepiece is unable to satisfactorily perform very simple tasks such as walking a straight line. The addition of an array of light restricting patterns to the Fresnel lens further simulates the effects of hallucinogenic drugs. The eyewear thus simulates bodily impairments similar to those produced by drug use. The eyewear is an excellent aid for teaching persons of the dangers of driving automobiles and operating other machines while under the influence of drugs.

Another embodiment of drug use simulating eyewear may use an eyepiece produced proximate the center of a Fresnel lens. In this embodiment, the eyepiece transverse centerline is coincident with a straight line through the center of the Fresnel lens. Further embodiments using a Fresnel lens include eyepieces in which the transverse centerlines are not coincident with any straight line through the Fresnel lens center. The nature of the visual distortions perceived by a person varies depending on the particular area of the Fresnel lens from which the eyepiece is produced. For all eyepiece constructions, however, bodily activities are severely impaired.

A method and apparatus of the present drug-use mimicking embodiment, using a single eyepiece made from a Fresnel lens, thus enables users to safely experience the effects of drug use. As in the previous embodiment, the visual distortions produced by the eyewear of the invention are temporary and can be terminated at will, even though the distortions are both realistic and economical to produce.

A method of simulating visual impairment is also envisioned, such a method includes the steps of: providing an eyewear, the eyewear having a frame member; the frame member having a frame opening therein and a groove member; providing a distortion producing eyepiece, wherein the distortion producing eyepiece is a lenticular prism lens having a plurality of refracting prisms, the eyepiece being retained in the frame opening by the groove member; and viewing an object through the eyepiece. Another method may use a Fresnel lens having an array of light restricting graphic markings as the distortion producing eyepiece. A method may include the further steps of providing the eyewear with a transparent cover member, the cover member having a predetermined color, wherein the predetermined color is in the red family. In an alternative method the predetermined color is in the red family.

### BRIEF DESCRIPTION OF THE DRAWINGS

FIG. 1 is a perspective view of an embodiment of eyewear according to the present invention and illustrating use of a lenticular prism lens.

FIG. 2 is a cross sectional view of the eyewear shown in FIG. 1 and taken along lines 2-2 thereof.

FIG. 3 is a view similar to that of FIG. 2, and showing a protective cover used with the eyewear.

FIG. 4 is a front view of a lenticular prism lens suitable for producing eyewear according to the present invention.

FIG. 5A is a cross sectional view of the lens of FIG. 4, illustrating a prism profile having a saw tooth pattern, and taken along lines 5A-5A thereof.

FIG. 5B is a view similar to that of FIG. 5A, but illustrating an alternative prism profile.

FIG. 5C is a view similar to that of FIGS. 5A and 5B, but illustrating an alternative prism profile.

FIG. 6 is a front view of the prism lens of FIG. 4 and marked with the outlines of eyepieces according to the present invention.

FIG. 7 is a perspective view of another embodiment eyewear according to the present invention and illustrating use of a Fresnel lens.

FIG. 8 is a front view of the eyewear illustrated in FIG. 7.

FIG. 9 is a cross sectional view of the eyewear shown in FIG. 7 and taken along lines 9-9 thereof.

FIG. 10 is a view similar to that of FIG. 9, and showing a protective cover used with the eyewear.

FIG. 11 is a front view of a Fresnel lens suitable for producing eyewear according to the present invention.

FIG. 11A is a cross sectional view of the lens of FIG. 11, illustrating a Fresnel lens profile, and taken along lines 11A-11A thereof.

FIG. 12 is a front view of a Fresnel lens, similar to that of FIG. 11, and showing an array of light restricting graphic markings on the lens.

FIG. 13 is a front view of the Fresnel lens shown in FIG. 12 and marked with the outlines of eyepieces according to the present invention.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

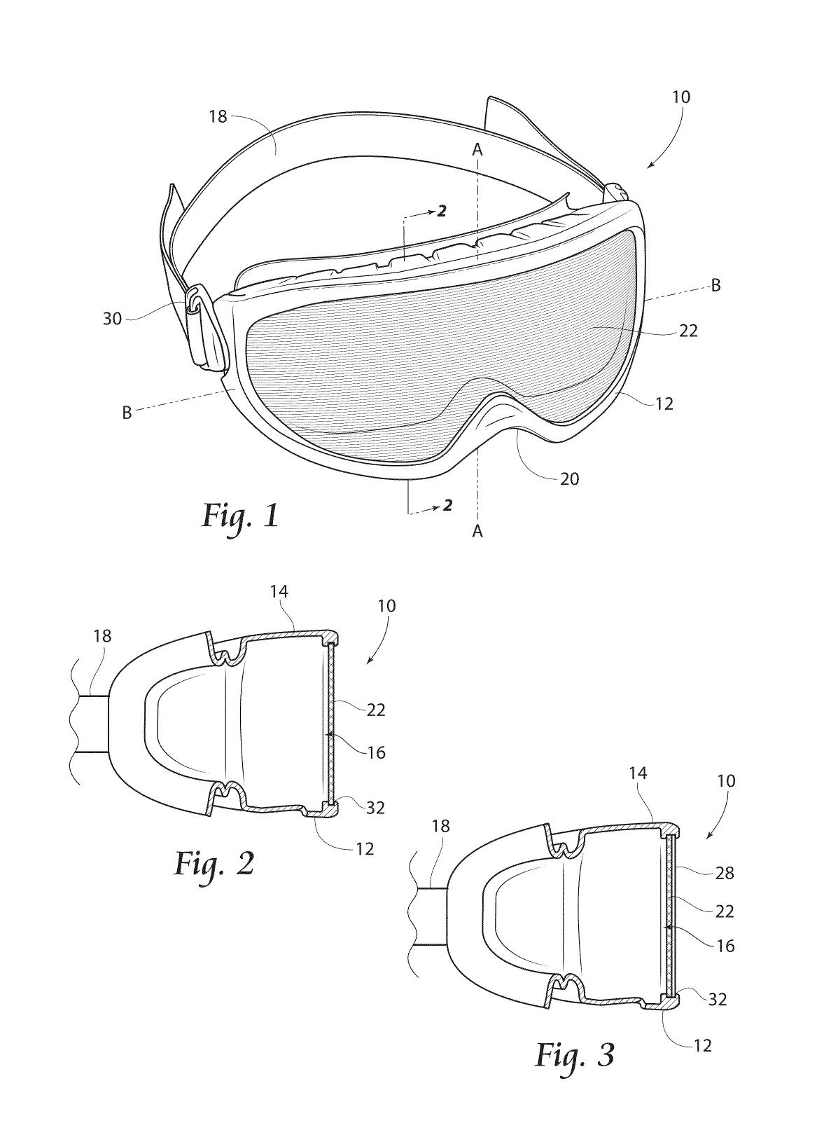

Referring to FIGS. 1 and 2, eyewear 10 according to the present invention is illustrated. Specifically, the eyewear 10 simulates sleep deprivation in the wearer. In a preferred embodiment, the eyewear 10 is in the form of a goggle 12 comprised of a frame 14 made of a semi-rigid material. The frame 14 surrounds and defines an opening 16. A band 18 is connected to the goggle 12 such as by rings 30, or other similar means for ease in wearing. The frame 14 preferably includes a groove 32 to receive an eyepiece 22 as will be discussed.

The frame opening 16 is long enough to span both eyes of a person wearing the goggle 12. The frame opening 16 defines a transverse centerline A-A and a longitudinal centerline B-B. A nose section 20 is generally symmetrical about the transverse centerline A-A. When the goggle 12 is worn, the transverse centerline A-A is approximately midway between the eyes of the wearer (not shown).

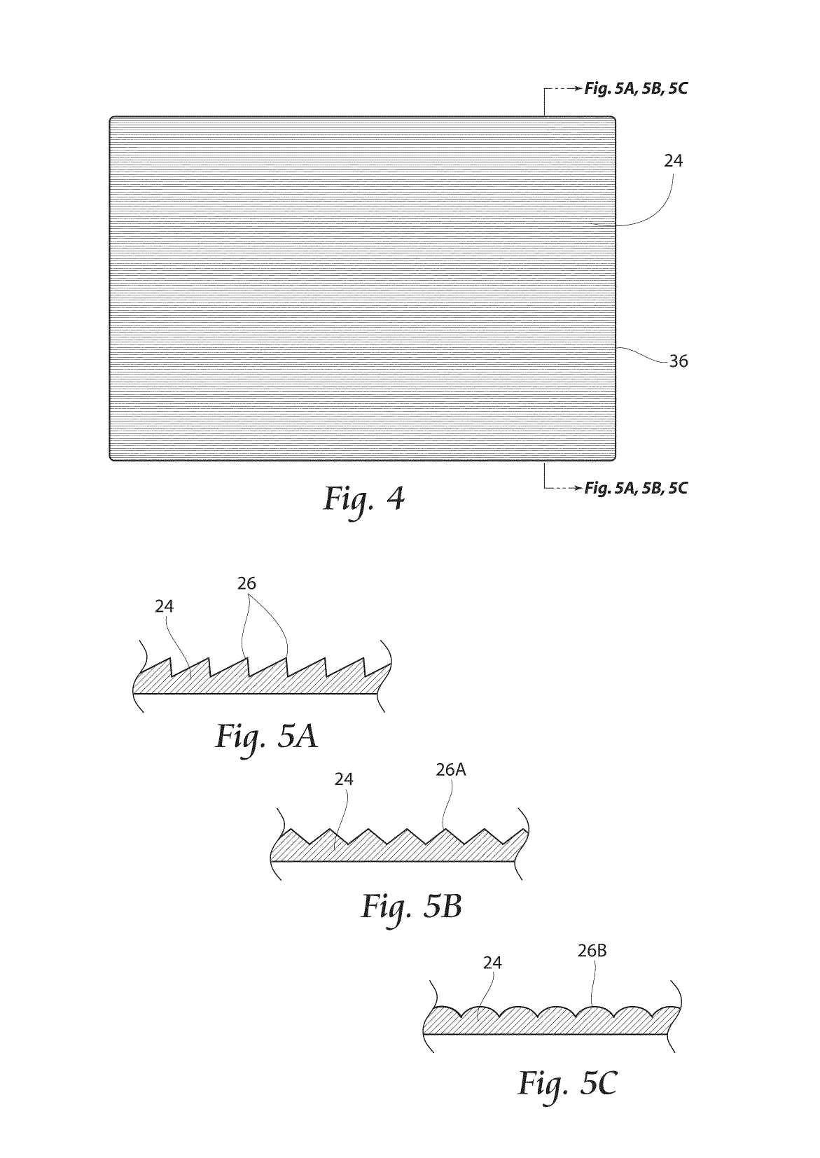

In accordance with the present invention, the eyewear 10 includes a distortion producing eyepiece 22 retained in a groove 32 in the eyewear 10 frame 14. The eyepiece 22 fills the entire goggle opening 16 and has a longitudinal centerline B-B that is coincident with the longitudinal centerline B-B of the frame opening 16, and a transverse centerline A-A that is coincident with the opening transverse centerline A-A. The eyepiece 22 used in the sleep deprivation eyewear 10, is preferably produced from a lenticular prism lens 24. The views of FIGS. 4-5C, illustrate lenticular prism lenses 24 for use with the present invention. The lens 24 is preferably made of a thin flexible sheet 36 of transparent plastic, or otherwise suitable material. Numerous light refracting prisms 26 may be formed on one side of the sheet 36. As is further shown, the refracting prisms 26 may have various cross sectional configurations, as is seen in the cross section views of FIG. 5A-5C. As shown, the prisms 26 may have a saw tooth cross section, as in FIG. 5A. FIG. 5B illustrates prisms 26A having a triangle cross section, while FIG. 5C shows prisms 26B having a rounded cross section. While the Figures illustrate preferred prism 26, 26A, 26B cross sections, it is to be understood that it is within the present invention to employ other prism cross sections, as may be desired. The refracting prisms 26, 26A, 26B preferably extend lengthwise across the sheet 36.

According to another aspect of the invention, the eyewear 10 may include a protective cover 28 over the eyepiece 22. As seen in FIG. 3, a transparent protective cover 28 of the same size and shape as the eyepiece 22 may be fit in the opening 16 together with the eyepiece 22. The cover 28 protects the eyepiece 22 against scratches and similar damage. It is preferred that the cover 28 be colored to further simulate time of day distortion, with colors in the blue family simulating sleep deprivation in the early morning hours and colors in the red family simulating dusk and early evening times.

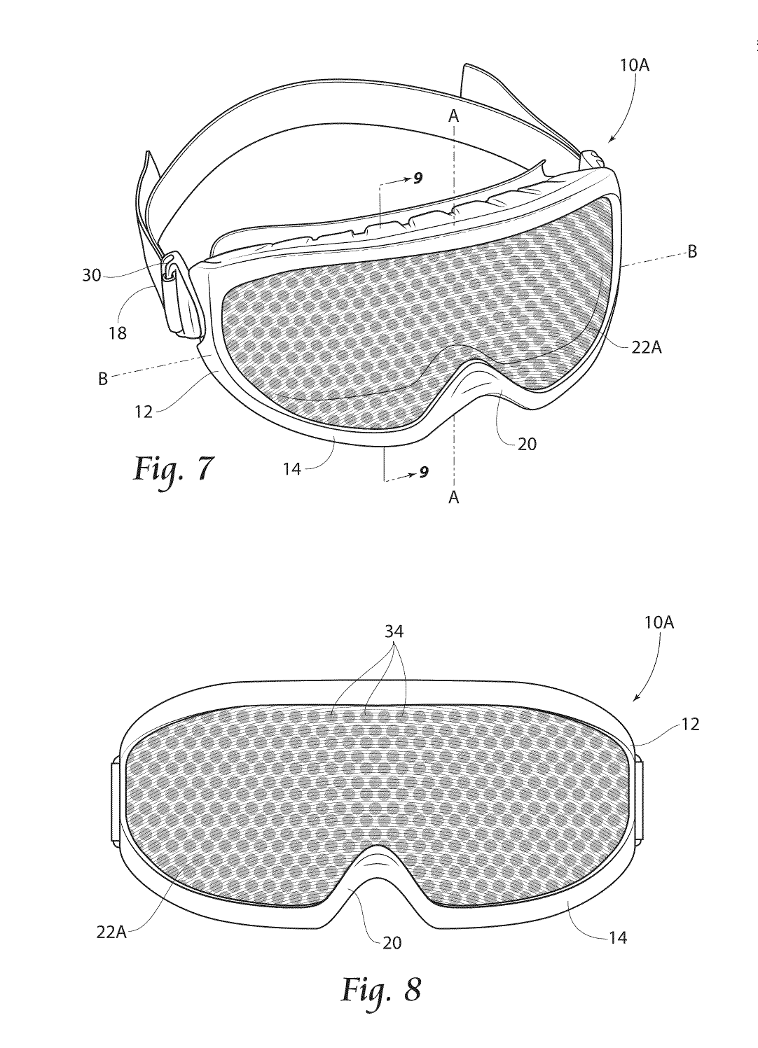

Referring now to FIGS. 7-13, another embodiment eyewear 10A according to the present invention is illustrated. Specifically, the eyewear 10A in these views simulates the visual effects of drug use on the wearer. As in the previous embodiment, the eyewear 10A is in the form of a goggle 12 comprised of a frame 14 made of a semi-rigid material. The frame 14 includes an opening 16. A band 18 is connected to the goggle 12 such as by rings 30, or other similar means. The frame 14 preferably includes a groove 22 to receive an eyepiece as will be discussed.

Similar to the previously described embodiment, the eyewear 10A shown in these views includes a frame opening 16 long enough to span both eyes of a person wearing the goggle 12. The frame opening 16 defines a transverse centerline A-A and a longitudinal centerline B-B. A nose section 20 is generally symmetrical about the transverse centerline A-A. When the goggle is worn, the transverse centerline A-A is located approximately midway between the eyes of the wearer (not shown).

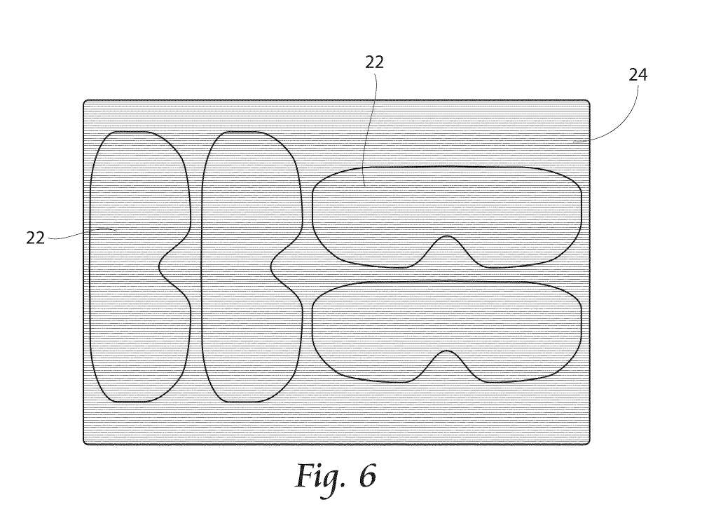

Similar to the eyewear 10 described with reference to FIGS. 1-6, the eyewear 10A shown in the views of FIGS. 7-13 includes a distortion producing eyepiece 22A retained in a frame groove 32. The eyepiece 22A fills the entire frame opening 16. The eyepiece 22A has a longitudinal centerline B-B that is coincident with the longitudinal centerline B-B of the frame opening 16, and a transverse centerline A-A that is coincident with the opening 16 transverse centerline A-A.

An eyepiece 22A for use with the drug simulating eyewear 10A is preferably produced from a Fresnel lens 24A. FIG. 11 illustrates a typical Fresnel lens 24A, in simplified fashion, for use with the present invention. A Fresnel lens 24A for use with the present invention is preferably made of a thin flexible sheet 36 of plastic material. Numerous light refracting prisms 26A may be formed on one side of the sheet 36. As shown in FIG. 11A, the refracting prisms 26A preferably have a triangular cross section, although other configurations may be envisioned. The refracting prisms 26A are preferably configured in closely spaced circles concentric about a center C.

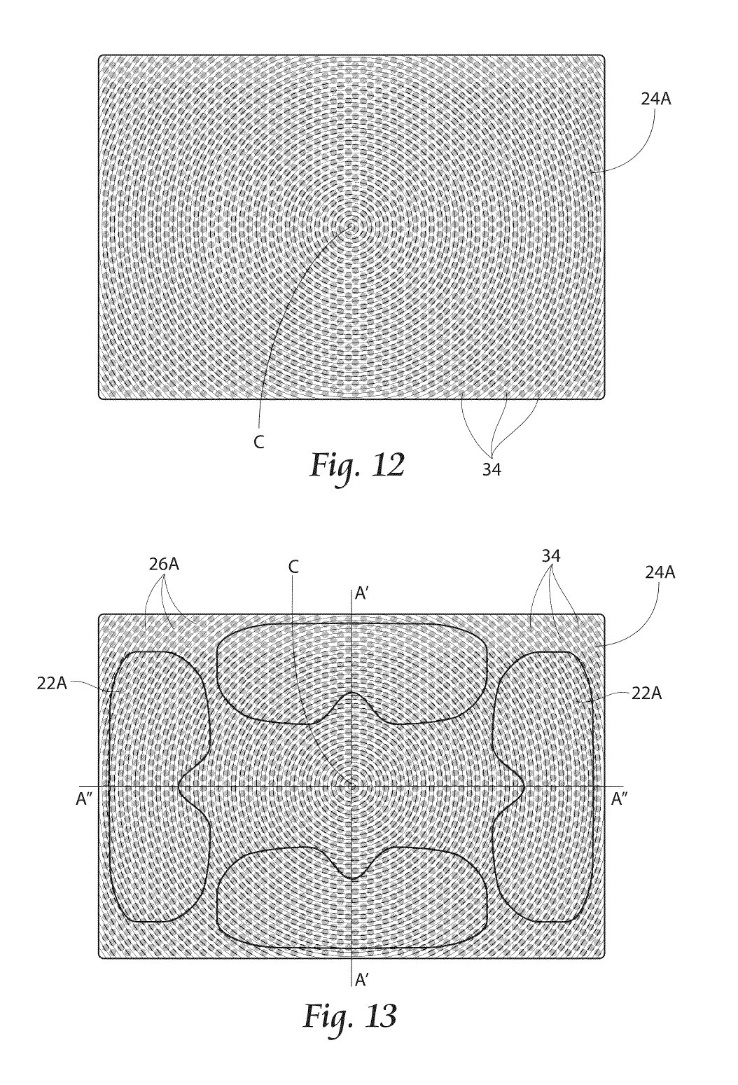

With attention now to FIG. 12, it may be seen that the lens 24A to be used with present invention further includes an array of light restricting graphic markings 34. The addition of an array of light restricting graphic markings 34 further simulates the effect of hallucinogenic drugs to the wearer. The markings 34 may permit some light to pass or may be opaque. Further, it is within the scope of the present invention that the markings 34 be colored according to the desired simulated experience. The eyewear 10A thus simulates bodily impairments similar to those produced by drug use.

In FIG. 13, four eyepieces 22A are shown in outline on a Fresnel lens 24A having light restricting markings 34. The transverse centerline A-A (see FIG. 7) of each eyepiece 22A is coincident with a straight line (here designated as lines A′-A′; A″-A″) through the Fresnel lens 24A center C. Although the eyepieces 22A may be formed anywhere along lines A-A; B-B, the eyepieces 22A are shown at the maximum distance from the Fresnel lens 24A center C. The view of FIG. 13 illustrates the longitudinal centerline B-B (see FIG. 7) of each eyepiece 22A as being generally parallel to the Fresnel lens 24A refracting prisms 26A of the eyepiece 22A.

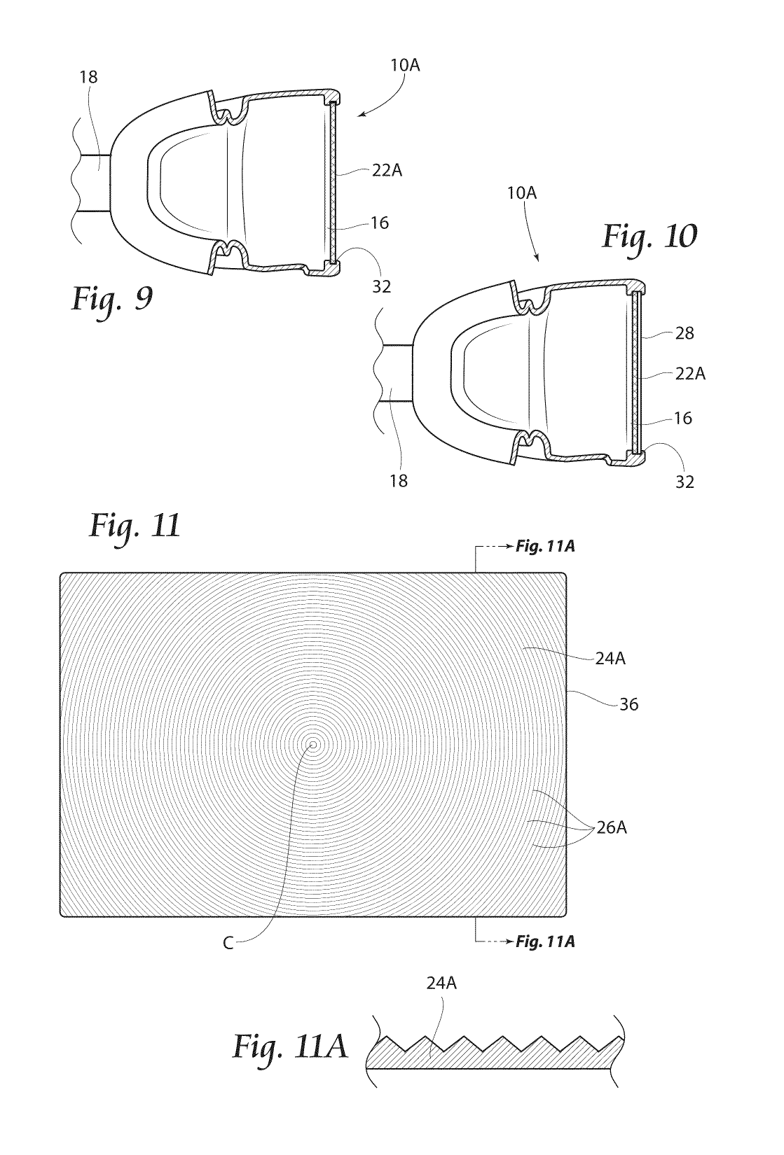

As shown, and similar to the previously described embodiment, the eyepiece 22A for the drug simulating eyewear 10A is cut such that the eyepiece 22A may fit in the goggle frame groove 32 (see FIG. 9). The semi-rigid material of the frame 14 permits the groove 32 to be manually opened to allow the eyepiece 22A to be inserted. The semi-rigid material of the frame 14 recloses the groove 32 after the eyepiece 22A is in place. Preferably, the refracting prisms 26A of the Fresnel lens 24A are placed facing the wearer (not shown).

To achieve the desired simulation, a person wearing the eyewear 10A views surrounding objects as distorted. The distortion created by the Fresnel lens 24A includes both a displacement of the objects from their true positions, and also as being misshapen relative to their true shapes. The array of light restricting graphic markings 34 on the Fresnel lens 24A further causes image restriction through the eyepiece 22A. The displacements seen by each eye of the wearer are generally symmetrical about the eyepiece transverse centerline A-A. A wearer viewing through the eyepiece 22A and Fresnel lens 24A perceives displacements as vertically upward and slightly to the opposite sides of the transverse centerline A-A. In addition, the curvatures of the long refracting prisms 26A cause the wearer to perceive the objects as being misshapen. Moreover, the array of light restricting graphic markings 34 causes the wearer to view the misshapen and displaced objects as incomplete since the markings 34 restrict complete view. The result is a sensation of dizziness, together with greatly diminished eye-hand coordination, and a feeling of being “high”. For practical purposes, the wearer is impaired from making many otherwise simple movements. The eyewear 10A is particularly useful as a safety related teaching aid because it harmlessly simulates visual impairments a person would have under the influence of drugs. A person who has worn the eyewear 10, 10A may be less inclined to abuse alcohol or drugs, having experienced in advance their effects on proper function. The particular distortions perceived by a wearer of the eyewear 10A may be varied depending on the particular region of the Fresnel lens 24A from which the eyepiece 22A is cut, the size and shape of the graphic markings 34, and even the color of the graphic markings 34. FIG. 13 illustrates eyepieces 22A cut with the nose sections 20 oriented toward the Fresnel lens 24A center C. However, it is to be understood that if desired, the eyepieces 22A may be rotated 180 degrees such that they are cut with the nose sections 20 oriented away from the Fresnel lens 24A center C. Other eyepiece 22A cut orientations may be envisioned without departing from the present invention.

As with the previous embodiment, the eyewear 10A may include a protective cover 36 over the eyepiece 22A. With reference to FIG. 10, the frame 14 may include a groove 32 of a size that is adapted to hold both an eyepiece 22A and a transparent cover 28 having a similar size and shape as the eyepiece 22A. The cover 28 helps to protect the eyepiece 22A from scratches and other damage.

The present invention uses a lenticular lens 24 or a Fresnel lens 24A for an eyepiece 22, 22A to safely simulate the effect of bodily impairments caused by drug and alcohol. The eyepiece 22A, when formed from a Fresnel lens 24A, may include an array of light restricting graphic markings 34 to further enhance the impairment. The eyewear 10, 10A of the present invention allows the wearer to experience such impairments temporarily, to inhibit performance of even simple manual tasks, and to thereby serve as a teaching tool. The distortions viewed through the eyepiece 22, 22A may be varied to suit different user requirements or to prevent a wearer from becoming acclimated to a particular distortion pattern. Varied distortions may be obtained by producing the eyepiece 22A from different areas of a Fresnel lens 24A, or by changing the size, pattern or color of the array of light restricting graphic markings 34. Other perceived distortions may be obtained by changing the color of the transparent cover 28 when used with either the lenticular lens 24 or Fresnel lens 24A.

It will also be recognized that in addition to the superior performance of the eyewear 10, 10A of the invention, its construction is such as to be of very modest cost in relation to the benefits it provides. Compared with the social costs of drug, alcohol, and similar impairments, the cost associated with the prevention of problems associated with such impairments is negligible. Moreover, the eyewear 10, 10A is of a simple design and rugged construction having long service life with little maintenance.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I/we claim:

1. An impairment simulating eyewear including:
a frame member; said frame member including a frame opening therein and a groove member; and
an eyepiece, said eyepiece being retained in said frame opening by said groove member.

2. The eyewear of claim 1 wherein said eyepiece is a distortion producing eyepiece.

3. The eyewear of claim 2 wherein said distortion producing eyepiece is a lenticular prism lens having a plurality of refracting prisms.

4. The eyewear of claim 2 wherein said distortion producing eyepiece is a Fresnel lens having an array of light restricting graphic markings.

5. The eyewear of claim 3 further including a transparent cover member, said cover member having a predetermined color.

6. The eyewear of claim 5 wherein said predetermined color is in the red family.

7. The eyewear of claim 5 wherein said predetermined color is in the blue family.

8. The eyewear of claim 1 wherein said frame opening is configured to span both eyes of a wearer.

9. The eyewear of claim 8 wherein said frame opening defines a transverse centerline and a longitudinal centerline.

10. The eyewear of claim 9 further including a nose section, said nose section being symmetrical about the transverse centerline.

11. The eyewear of claim 10 further including a band member attached to said frame member.

12. The eyewear of claim 8 wherein said eyepiece spans said frame opening.

13. A method of simulating visual impairment including the steps of:
providing an eyewear, said eyewear having a frame member; said frame member including a frame opening therein and a groove member;
providing a distortion producing eyepiece, said eyepiece being retained in said frame opening by said groove member; and
viewing an object through said eyepiece.

14. The method of claim 13 wherein said distortion producing eyepiece is a lenticular prism lens having a plurality of refracting prisms.

15. The method of claim 13 wherein said distortion producing eyepiece is a Fresnel lens having an array of light restricting graphic markings.

16. The method of claim 14 further including the step of providing said eyewear with a transparent cover member, said cover member having a predetermined color.

17. The method of claim 16 wherein said predetermined color is in the red family.

18. The method of claim 16 wherein said predetermined color is in the red family.
